(19) United States
(12) Patent Application Publication
(10) Pub. No.: US 2005/0219506 A1
(43) Pub. Date: Oct. 6, 2005

(54) Object recognition device for vehicle

(76) Inventors: Keiko Okuda, Ogaki-city (JP); Tsutomu Natsume, Nagoya-city (JP); Yoshie Samukawa, Kariya-city (JP)

Correspondence Address: HARNESS, DICKEY & PIERCE, P.L.C., P.O. BOX 828, BLOOMFIELD HILLS, MI, 48303, US

(21) Appl. No.: 11/093,836

(22) Filed: Mar. 30, 2005

(30) Foreign Application Priority Data
Mar. 31, 2004 (JP) 2004-104120

(51) Int. Cl. G01P 3/36; G01S 13/00; G01S 13/08

(52) U.S. Cl. 356/28; 342/104; 342/95; 356/28.5

(57) ABSTRACT

An object recognition device includes a radar unit, a recognition range setting means, a recognition means, a speed detection means, and a recognition range switching means. The radar unit is for emitting transmission waves in a plurality of angular ranges within a recognition range set from the plurality of angular ranges and for receiving reflected transmission waves from a reflecting object. The recognition range setting means sets the recognition range and instructs the radar unit to emit the transmission waves. The recognition means recognizes the reflecting object based on a result of emission and receipt of waves by the radar unit. The speed detection means detects a vehicle speed. The recognition range switching means switches the recognition range to a new recognition range when the detected speed is smaller than a predetermined speed.

### CROSS REFERENCE TO RELATED APPLICATIONS

This application is based upon and claims the benefit of priority of Japanese Patent Application No. 2004-104120, filed on Mar. 31, 2004, the contents of which are incorporated herein by reference.

### FIELD OF THE INVENTION

The present invention relates to an object recognition device for a vehicle that emits transmission waves in a predetermined angular range in each of a vehicle-width direction and a vehicle-height direction and recognizes an object in front of the vehicle based on reflected transmission waves.

### BACKGROUND OF THE INVENTION

Conventionally, a distance detection device (laser radar) that is attached to a vehicle for measuring a distance between the vehicle and an obstacle in front of the vehicle such as another vehicle by using laser light, for example, is known. That distance detection device makes a laser diode intermittently emit light so as to radiate that light ahead of the vehicle, detects light reflected from the obstacle ahead of the vehicle by a photosensor, and measures the distance between the vehicle and the obstacle in front of the vehicle based on a time difference between a time of light emission and a time at which the reflected light was received.

The distance detection device includes a light-emitting portion for emitting laser light, a polygon mirror serving as a rotatable scan mirror for reflecting the laser light, and a light-receiving portion for receiving the reflected laser light. The polygon mirror has a shape of a truncated six-sided pyramid. With this structure, the distance detection device makes the polygon mirror reflect the laser light emitted from the light-emitting portion so as to radiate that laser light ahead of the vehicle. In this operation, the polygon mirror is rotated in such a manner that each side face is irradiated with the laser light from the light-emitting portion, thereby adjusting the angle of reflection of the laser light by the polygon mirror and scanning a predetermined range ahead of the vehicle with the laser light. Then, regarding a reflector on a leading vehicle as a reflecting object in the obstacle, for example, the light-receiving portion receives the laser light reflected from the reflector. In this manner, the distance from the obstacle is measured (see Japanese Patent Laid-Open Publication No. 2002-031685, for example).

The conventional distance detection device scans a predetermined range with the laser light emitted ahead of the vehicle up and down and from side to side, for example. This scanning range is determined in advance considering a distance that can be detected by the distance detection device, and is set to about 4 deg in a vertical direction (vehicle-height direction) and about ±18 degrees in a lateral direction (vehicle-width direction), for example.

In the case of setting the scanning range in the aforementioned manner, however, when the leading vehicle is a high vehicle in which a reflector is attached at a high level, such as a truck, the reflector's level is higher than the range irradiated with the laser light and therefore the laser light is not incident on the reflector. Especially, in the case where the distance detection device is attached to a lower portion of the vehicle, such as a lower part of the bumper, the above problem occurs more frequently. Therefore, when the vehicle with the distance detection device comes close to the truck or the like, the laser light goes off the reflector, thus suddenly making the distance detection inoperative.

### SUMMARY OF THE INVENTION

The present invention was made in light of the above problem. It is an object of the present invention to provide an object recognition device for a vehicle that can emit transmission waves to a reflecting object in an obstacle and can accurately detect a distance between the vehicle and the obstacle even in the case where the reflecting object is arranged at a high level in the obstacle as in the case where the obstacle is a high vehicle.

In order to achieve the above object, according to one aspect of the present invention, a distance detection device comprises speed detection means for detecting a speed of the vehicle; and recognition range switching means for switching a recognition range in a low-speed state in which the speed detected by the speed detection means is smaller than a predetermined speed, so as to set a new recognition range from a plurality of angular ranges that can be scanned by scan means in such a manner that transmission waves are emitted to a higher level than the recognition range that was set before switching.

As described above, when the vehicle with the distance detection device gets into the low-speed state, it is more likely that a distance between that vehicle and a leading vehicle becomes short. Therefore, the recognition range switching means switches the recognition range so that the transmission waves are emitted to a higher level than the recognition range set before the switching. Thus, even when the vehicle with the distance detection device comes close to a truck or the like, the laser light is emitted to a higher level so as to be incident on a reflector arranged at a high position on the truck or the like.

Therefore, it is possible to prevent occurrence of a situation in which the distance detection suddenly becomes inoperative because the distance from the truck or the like becomes short and the laser light goes off the reflector.

According to a further aspect of the invention, the distance detection device further comprises leading vehicle determination means for determining that a reflecting object recognized by the recognition means is a leading vehicle and obtaining a distance from the leading vehicle. The recognition range switching means switches the recognition range in a short-distance state in which the distance from the leading vehicle that was detected by the leading vehicle determination means is shorter than a predetermined distance, thereby setting a new recognition range from the plurality of angular ranges that can be scanned by the scan means in such a manner that the transmission waves are emitted to a higher level than the recognition range set before the switching.

As described above, the recognition range may be switched when the distance from the leading vehicle becomes shorter than the predetermined distance. In this case, the same effects as those of the above-described aspect of the present invention can be obtained.

Another aspect of the present invention is applied to a case of using a polygon mirror having a plurality of side faces of different angles with respect to a bottom face. In this case, the recognition range setting means stores face numbers of the side faces of the polygon mirror in accordance with the angles thereof, and makes the side faces of the face numbers corresponding to the recognition range reflect the transmission waves so as to emit the transmission waves in the recognition range.

Thus, the recognition range switching means sets the face numbers of the side faces of the polygon mirror that emit the transmission waves to a higher level than the side faces of the face numbers stored in the recognition range setting means, as the face numbers corresponding to the new recognition range, and makes the side faces of the face numbers corresponding to the new recognition range emit the transmission waves.

For example, in the case where the side faces of the polygon mirror are numbered in an order from the side face emitting the transmission waves to a highest level in the vehicle-height direction to the side face emitting the transmission waves to a lowest level, the recognition range switching means switches the face numbers corresponding to the recognition range to the face numbers of the side faces emitting the transmission waves to a higher level in the vehicle-height direction than the side faces of the face numbers corresponding to the recognition range before the switching.

In this case, when the recognition range setting means sets a face number of a side face of the polygon mirror which corresponds to a predetermined reference angle with respect to a forward direction of the vehicle, and face numbers on both sides of the above face number, it is preferable that the recognition range switching means switch the face numbers corresponding to the, recognition range to face numbers of side faces emitting the transmission wave to a higher level in the vehicle-height direction and the face number of the side face corresponding to the predetermined reference angle.

By so doing, it is possible to emit the transmission waves to a higher level in the vehicle-height direction while detecting a distant object.

Moreover, in the case where the side faces of the polygon mirror are numbered in an order from the side face emitting the transmission waves to the highest level in the vehicle-height direction to the side face emitting the transmission waves to the lowest level, the recognition range switching means may decrease or increase the face numbers corresponding to the recognition range by one before switching.

Other features and advantages of the present invention will be appreciated, as well as methods of operation and the function of the related parts from a study of the following detailed description, appended claims, and drawings, all of which form a part of this application. In the drawings:

### BRIEF DESCRIPTION OF THE DRAWINGS

FIG. 1 is a block diagram of a vehicle control device in accordance with the present invention;

FIG. 2A is a block diagram of a laser radar sensor of the vehicle control device of FIG. 1;

FIG. 2B is a graph for explaining a distance detection method of the laser radar sensor of FIG. 2A;

FIG. 3 is a perspective view of a region that can be irradiated by the laser radar sensor of FIG. 2A;

FIG. 4 is a graphical representation of a divergence angle and an overlapping range of laser light beams emitted from the laser radar sensor of FIG. 2A;

FIG. 5 is a graphical diagram expressing a process for setting a recognition range of the laser radar sensor of FIG. 2A;

FIG. 6 is a perspective view of a positional relationship of a vehicle and a target;

FIG. 7 is a flowchart of a process for setting a recognition range of the laser radar sensor of FIG. 2A;

FIG. 8 is a graphical representation of an intensity distribution of reflected laser light taken along an X-axis direction within an irradiation angular range of laser light corresponding to a tolerance range of an attaching angle of the laser radar sensor of FIG. 2A;

FIG. 9 is a graphical representation of an intensity distribution of reflected laser light taken along a Y-axis direction within the irradiation angular range of the laser light corresponding to the tolerance range of the attaching angle of the laser radar sensor of FIG. 2A;

FIG. 10 is a flowchart of a process for calculating a vertical optical axis learning angle in accordance with the present invention;

FIG. 11 is a graphical representation of a relationship between an attaching level of the laser radar sensor of FIG. 2A and a reference angle that is a target of a Y-axis central laser light;

FIG. 12 is a graphical representation of a method for calculating a deviation angle in accordance with the present invention;

FIG. 13A is a flowchart of an object recognition process in accordance with the present invention;

FIG. 13B is a flowchart of a targeting process performed in the process shown in FIG. 13A;

FIG. 14 is a flowchart of a process for learning an optical center of the laser radar sensor in accordance with the present invention;

FIG. 15 is a graphical representation of a face number detected by a reflector in accordance with the present invention;

FIG. 16 is a flowchart of a process for switching the recognition range in accordance with the present invention;

FIG. 17A is a graphical representation of an irradiation angle of laser light when the recognition range of the present invention is not switched; and

FIG. 17B is a graphical representation of an irradiation angle of laser light when the recognition range of the present invention is switched.

### DETAILED DESCRIPTION OF THE PREFERRED EMBODIMENTS

Embodiments of the present invention are now described with reference to the accompanying drawings. In the following embodiments, components that are the same or equivalent are labeled with the same reference numerals.

A vehicle control device 1 to which an object recognition device for vehicle of the present invention is applied is now described with reference to the accompanying drawings. The vehicle control device 1 is attached to an automobile for giving an alarm when there is an obstacle in a region for which the alarm has to be given and controlling the speed of the automobile in accordance with a forward vehicle (leading vehicle).

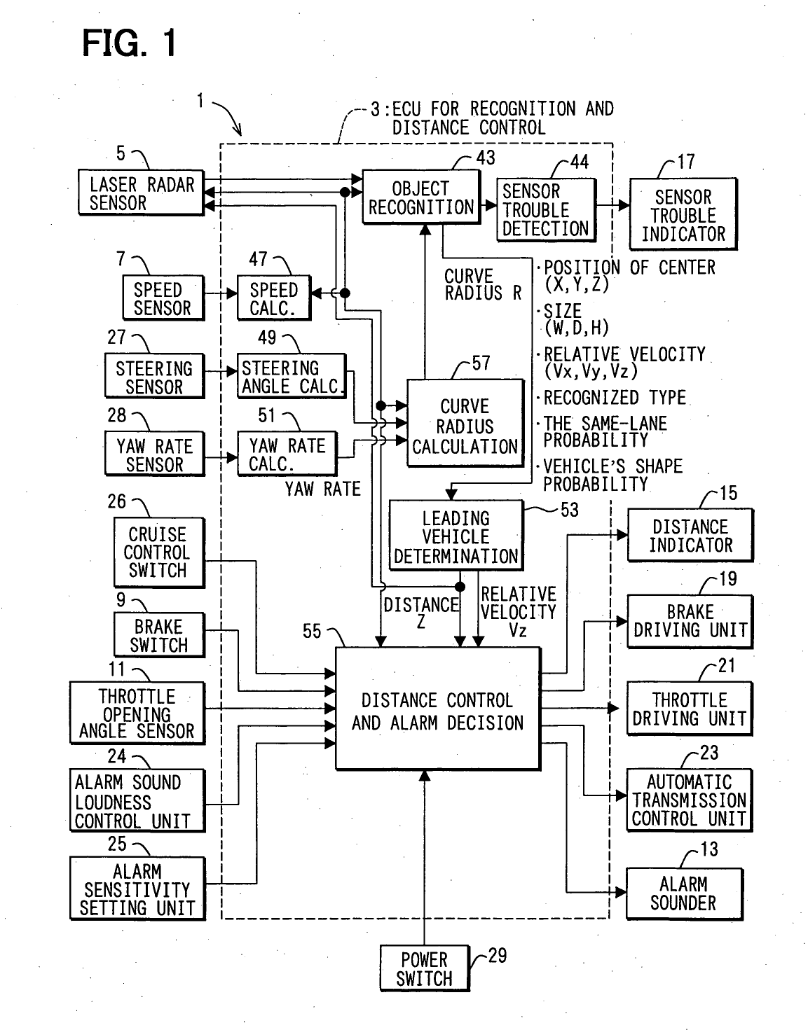

FIG. 1 is a system block diagram of the vehicle control device 1. The vehicle control device 1 is mainly formed by an ECU for recognition and distance control 3. The ECU for recognition and distance control 3 is mainly formed by a microcomputer and includes an input-output interface (I/O), various driving circuits, and detection circuits. The hardware structure of the ECU 3 is common and therefore the description thereof is omitted.

The ECU for recognition and distance control 3 receives detection signals from a laser radar sensor 5, a speed sensor 7, a brake switch 9, and a throttle opening angle sensor 11 as inputs, and outputs driving signals to an alarm sounder 13, a distance indicator 15, a sensor trouble indicator 17, a brake driving unit 19, a throttle driving unit 21, and an automatic transmission control unit 23. Moreover, an alarm sound loudness setting unit 24 for setting the loudness of the alarm sound, an alarm sensitivity setting unit 25 for setting the sensitivity in an alarm decision process, a cruise control switch 26, a steering sensor 27 for detecting the operated amount of a steering wheel (not shown), and a yaw rate sensor 28 for detecting a yaw rate occurring in the vehicle are connected to the ECU for recognition and distance control 3. The ECU for recognition and distance control 3 further includes a power switch 29 and starts a predetermined process when the power switch 29 is turned on.

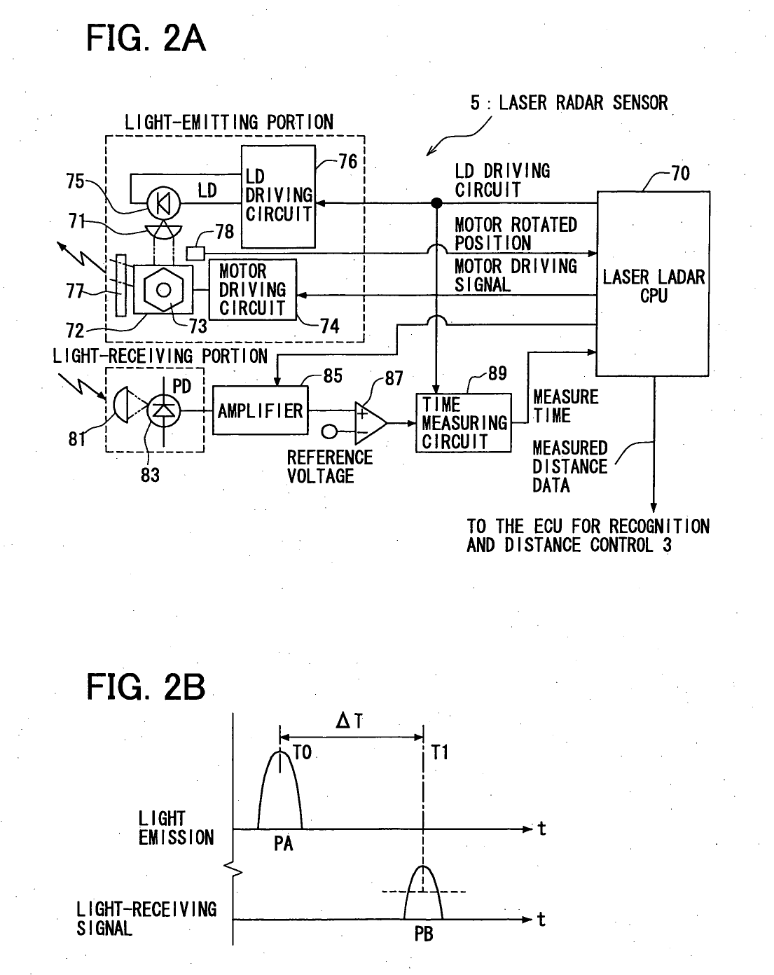

The laser radar sensor 5 is driven based on a control signal from the ECU for recognition and distance control 3, and is formed mainly by a light-emitting portion, a light-receiving portion, and a laser radar CPU 70, as shown in FIG. 2A. In other words, the laser radar sensor 5 includes the light-emitting portion and light-receiving portion as a radar unit and also includes the laser radar CPU 70 for calculating a distance from a reflecting object and positions of the reflecting object in a vehicle-width direction and a vehicle-height direction from the detection results in the light-emitting portion and light-receiving portion.

The light-emitting portion includes a semiconductor laser diode (hereinafter, simply referred to as laser diode) 75 that radiates pulse-like laser light through a light-emitting lens 71, a scanner 72, and a glass plate 77. The laser diode 75 is connected to the laser radar CPU 70 through a laser diode driving circuit 76 and radiates (emits) laser light by a driving signal from the laser radar CPU 70. The scanner 72 includes a polygon mirror 73 as a reflecting member that is rotatably provided. When a driving signal from the laser radar CPU 70 is input to the polygon mirror 73 through a motor driving circuit 74, the polygon mirror 73 is rotated by a driving force of a motor (not shown). A motor rotated position sensor 78 detects the rotated position of the motor and outputs it to the laser radar CPU 70.

The polygon mirror 73 has a shape of an approximately truncated six-sided pyramid. That is, six side faces form mirrors. Since the angle of the side face with respect to the bottom face of the polygon mirror 73 is different for each of the side faces, the polygon mirror 73 can output laser light so as to discontinuously scan a predetermined angular range in each of the vehicle-width direction and vehicle-height direction with the laser light. In the present embodiment, the side faces of the polygon mirror 73 are numbered as the first face, the second face, . . . , and the sixth face in the order of the magnitude of the angle of the side face with respect to the bottom face.

The light-receiving portion of the laser radar sensor 5 includes a light-receiving lens 81 and a light-receiving element (photodiode) 83. The light-receiving element 83 receives the laser light reflected from an object (not shown) through the light-receiving lens 81 and outputs a voltage corresponding to the intensity of the received light. An amplifier 85 amplifies the output voltage of the light-receiving element 83 and outputs the amplified voltage to a comparator 87. The comparator 87 compares the output voltage of the amplifier 85 with a reference voltage, and outputs a predetermined light-receiving signal to a time measuring circuit 89 when the output voltage is larger than the reference voltage.

The driving signal output from the laser radar CPU 70 to the laser diode driving circuit 76 is also input to the time measuring circuit 89. Then, as shown in FIG. 2B, assuming that driving signal and the light-receiving signal to be a start pulse PA and a stop pulse PB, respectively, the time measuring circuit 89 codes a phase difference between those two pulses PA and PB (i.e., a time difference ΔT between a time T0 at which the laser light is emitted and a time T1 at which the reflected light is received) into a binary digital signal. The time measuring circuit 89 also measures a pulse width of the stop pulse PB as time.

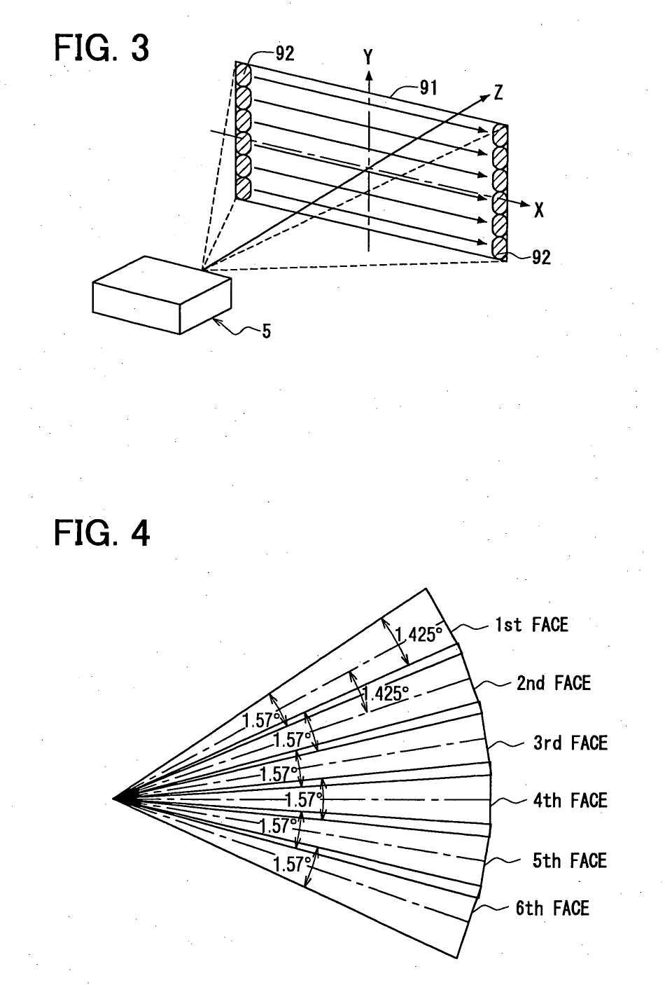

Next, an irradiatable area that can be irradiated with the laser light and a recognition range that is used for actual recognition of an object such as a leading vehicle are described with reference to FIGS. 3 to 9.

FIG. 3 is a perspective view showing an irradiation area of the laser radar sensor. Laser beams are output from the right end to the left end in a measurement area 121 at a regular interval, for example, although FIG. 3 shows patterns 122 of the light beams at the right and left ends of the measurement area 121 only. The pattern 92 of the laser light beam is an elliptical pattern in the example of FIG. 3. However, the shape of the pattern 92 of the laser light beam is not limited thereto. The laser light pattern may be rectangular, for example. Moreover, instead of the laser light, electric waves such as millimeter waves, ultrasonic waves, or the like may be used. Furthermore, any scanning method can be used, as long as it allows for measurement of orientations in X and Y-axis directions in addition to the distance.

As shown in FIG. 3, the laser radar sensor 5 can sequentially scan an irradiatable area 91 in X-Y plane perpendicular to Z-axis, where Z-axis is the irradiation direction of the laser light.

FIG. 4 shows a divergence angle in Y-axis direction of the laser light beam reflected from each side face (the first to sixth faces) of the polygon mirror 73 and an overlapping range of laser light beams adjacent in Y-axis direction. In the present embodiment, the irradiation angle of the laser light beam is set in such a manner that the laser light beams adjacent in the vehicle-height direction (Y-axis direction) partially overlap in their boundaries, as shown in FIG. 4. More specifically, each laser light beam has a divergence angle of 1.57 deg. In the range of 1.57 deg, the adjacent laser light beams overlap in a range of 0.145 deg. Thus, an angle between the central axes of the adjacent laser light beams is 1.425 deg.

Setting the irradiation angle of the laser light beam in the aforementioned manner can improve the resolution in Y-axis direction. More specifically, in the case where the laser light beams in FIG. 4 are numbered as the first-face light beam, the second-face light beam, and the third-face light beam from top down, five patterns can be considered that contain a pattern obtained when only the first-face laser light beam is reflected, a pattern obtained when the first-face and second-face laser light beams are reflected, a pattern obtained when only the second-face laser light beam is reflected, a pattern obtained when the second-face and the third-face laser light beams are reflected, and a pattern obtained when only the third-face laser light beam is reflected. Especially, because the second-face laser light beam has the overlapping regions on both sides, the degree of improvement of the resolution can be enhanced around the second-face laser light beam.

When it is assumed the X-axis direction as the vehicle-width direction and Y-axis direction as the vehicle-height direction are a scanning direction and a reference direction, respectively, the irradiatable area 91 in the present embodiment is 0.08 deg×501 points=±20 deg in X-axis direction and 1.57 deg×6 lines−0.145 deg×5 (the number of overlapping regions)=8.695 deg in Y-axis direction. In addition, the scanning is performed from left to right in FIG. 3 for X-axis direction, while being performed from top down in FIG. 3 for Y-axis direction.

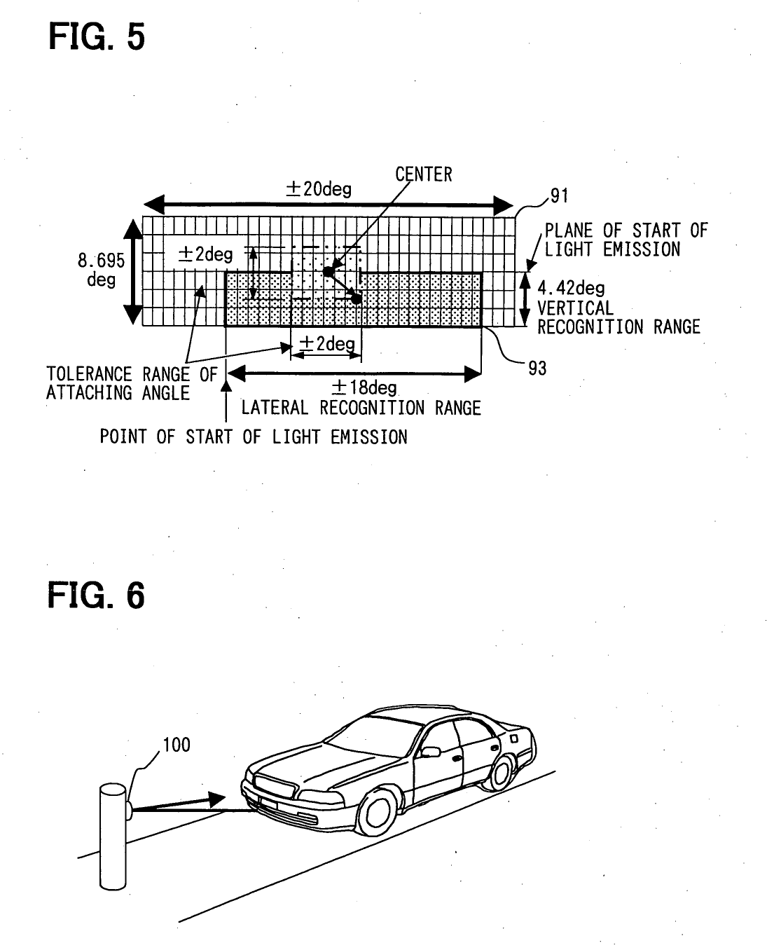

Next, the recognition range 93 is described based on FIGS. 5 to 9. The laser radar sensor 5 is attached to the front face of the vehicle, for example, on the lower part of the bumper. The laser light emitted from the laser radar sensor 5 should be precisely directed to an object ahead of the present vehicle, i.e., a leading vehicle, a delineator (cat's-eye) used for determining a driving lane, a guardrail, or the like. Thus, it is necessary to attach the laser radar sensor 5 to the vehicle while matching an attaching angle of the laser radar sensor 5 with a reference attaching angle, in order to prevent the irradiation area of the laser light from being deviated upward or downward, or to the right or left side.

The matching of the attaching angle of the laser radar sensor 5 can be achieved by mechanical adjustment in which a worker adjusts the attaching angle by using a mechanical means such as an adjusting bolt. However, as a tolerance range of the attaching angle with respect to the reference attaching angle becomes smaller, the mechanical adjustment becomes more difficult and the time required for the mechanical adjustment increases.

Therefore, in the present embodiment, adjustment by a software process in the laser radar sensor 5 is performed in addition to the mechanical adjustment, thereby matching the angular range of the laser light emitted from the laser radar sensor 5 with a desired reference angular range.

FIG. 6 is a view showing the adjustment by software. During the adjustment by software, a target 100 having high reflectivity with respect to laser light is arranged at a predetermined level above the ground, as shown in FIG. 6. A vehicle with the laser radar sensor 5 is moved to a position away from the target 100 by a predetermined distance.

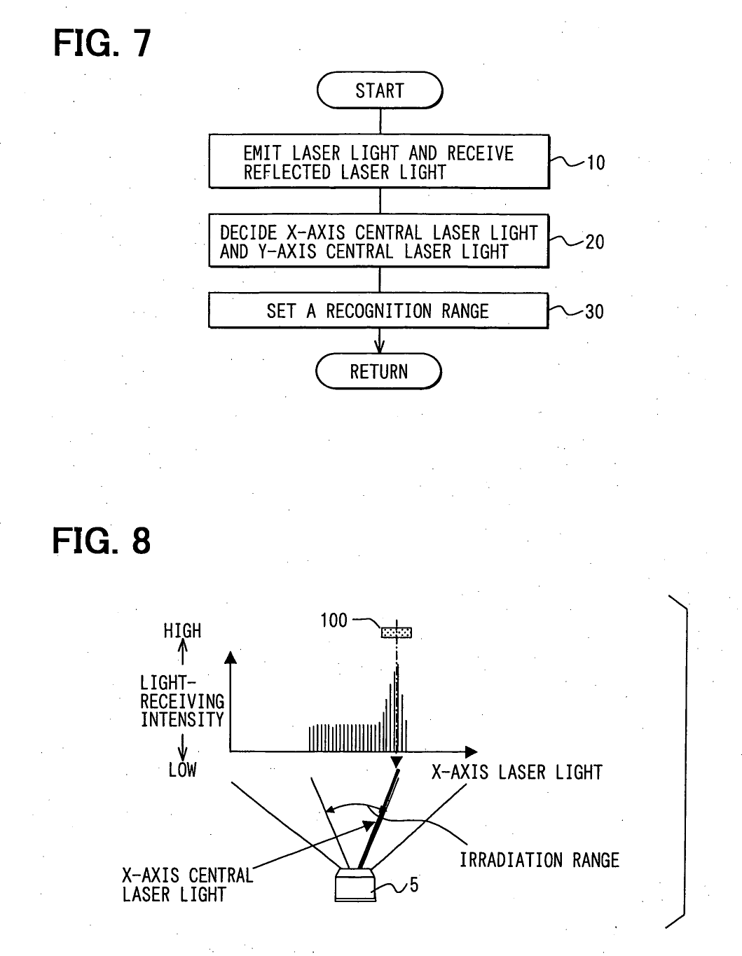

In the above state, the vehicle control device is operated to make the laser radar CPU 70 perform a process shown in a flowchart of FIG. 7, thereby setting the recognition range 93. First, the light-emitting portion emits laser light toward the target 100 and the light-receiving portion receives the reflected laser light in Step 10. The irradiation angular range of the laser light in this emission is regarded as being coincident with the tolerance range of the attaching angle of the laser radar sensor 5, as shown in FIG. 5. In the example of FIG. 5, the tolerance range is ±2 deg in each of the vehicle-width direction and vehicle-height direction. This tolerance range is set to be larger, as compared with that in the conventional technique.

Please note that the target 100 is arranged in such a manner that it is located on the center of the irradiation angular range of the laser light when the attaching angle of the laser radar sensor 5 is coincident with the reference attaching angle. Thus, when the laser light is emitted in the irradiation angular range corresponding to the tolerance range of the attaching angle of the laser radar sensor 5, the laser radar sensor 5 can always receive the light reflected from the target 100.

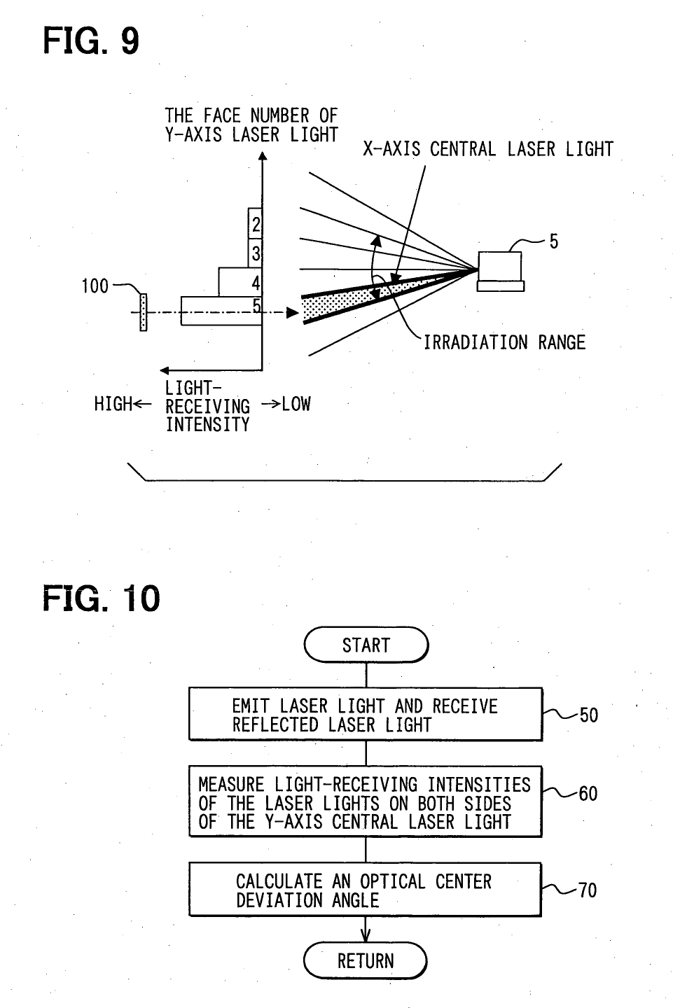

In Step 20, laser light corresponding to the received reflection waves having the highest light-receiving intensity is determined as central laser light in each of X and Y-axis directions. The determination of the central laser light is now described, with reference to FIGS. 8 and 9. FIG. 8 shows the light-receiving intensity of the light reflected from the target 100 when the laser light is scanned in X-direction in the aforementioned irradiation angular range of the laser light. FIG. 9 shows the light-receiving intensity of the light reflected from the target 100 when the laser light is scanned in Y-axis direction in the irradiation angular range of the laser light. As is apparent from FIGS. 8 and 9, the laser light corresponding to the reflected light having the highest light-receiving intensity is determined as X-axis central laser light or Y-axis central laser light.

In the example of FIGS. 8 and 9, the position of the target 100 is the farthest from the center of the tolerance range of the attaching angle of the laser radar sensor 5 (by +2 deg in X and Y-axis directions). Therefore, the laser light emitted at an end of the irradiation angular range of the laser light is determined as the X-axis central laser light and the Y-axis laser light.

In Step 30, the recognition range 93 is set based on the thus determined X and Y-axis central laser lights in the following manner. As shown in FIG. 5, a range of ±18 deg (corresponding to 451 laser light beams) from the X-axis central laser light in X-axis direction is decided as a horizontal range of the recognition range 93. Similarly, a range of 4.42 deg (corresponding to 3 laser light beams) from the Y-axis central laser light in Y-axis direction is decided as a vertical range of the recognition range 93. Thus, the range defined by the above horizontal range and vertical range is the recognition range 93. Then, the face number of the side face of the polygon mirror 73 corresponding to the recognition range 93 is stored in a memory or the like of the laser radar CPU 70. During actual recognition of an object such as a leading vehicle, scanning is performed by irradiating the side face of the polygon mirror 73 corresponding to the recognition range 93 with the laser light.

Due to the aforementioned setting of the recognition range 93 using the target 100, the central laser light located on the center of the recognition range 93 can be adjusted to a reference angle that is a target of the central laser light. As a result, the recognition range 93 thus set is also coincident with a desired recognition area.

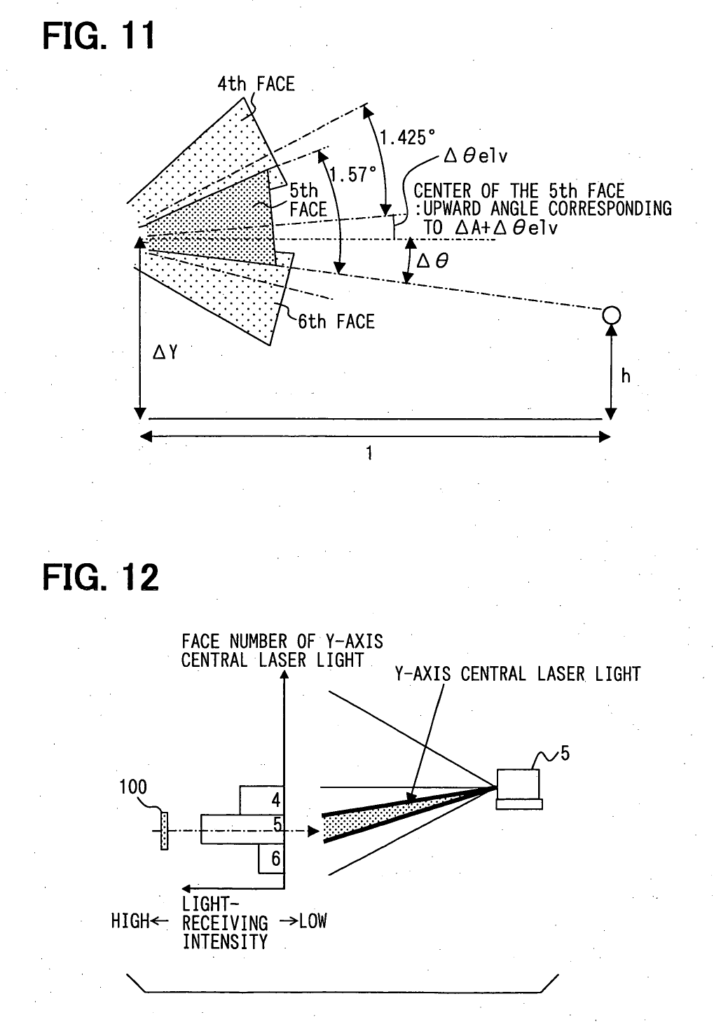

However, the resolution of the laser light in X-axis direction is 0.08 deg, whereas the divergence angle of the laser light in Y-axis direction is 1.57 deg and therefore the resolution of the laser light in Y-axis direction is lower than that in X-axis direction. Therefore, a process for calculating a vertical optical axis learning angle is performed in order to more precisely recognize the irradiation angle of the central laser light in Y-axis direction. That calculation process is now described with reference to a flowchart of FIG. 10 and diagrams of FIGS. 11 and 12.

First, a relationship between an attaching level ΔY of the laser radar sensor 5 and a reference angle ΔA that is the target of the Y-axis central laser light is described based on FIG. 11. The laser radar sensor 5 is attached to the lower part of the bumper of the vehicle, for example. The attaching level ΔY of the laser radar sensor 5 is varied depending on the type of vehicle. In the case where the attaching level ΔY is low, i.e., the laser radar sensor 5 is attached at a low position above the ground, it is preferable that the angle of the center of the Y-axis central laser light be set to be upward. On the other hand, in the case where the attaching level ΔY is large, it is preferable that the angle of the center of the Y-axis central laser light be set to be approximately horizontal.

As described above, the reference angle that is the target of the angle of the center of the Y-axis central laser light is varied depending on the attaching level ΔY of the laser radar sensor 5. Thus, in the present embodiment, that reference angle is represented with ΔA and is determined for every type of vehicle. For example, the reference angle ΔA is set to 0.5 deg for a type of vehicle which provides the lower attaching level ΔY, and is set to 0 deg for a type of vehicle which provides the higher attaching level ΔY. Then, the vertical optical axis learning angle Δθelv (deviation angle) described below is calculated as deviation of the angle of the center of the Y-axis central laser light from the reference angle ΔA.

In Step 50 in FIG. 10, after the recognition range 93 is set, the Y-axis central laser light and laser lights on both sides of the Y-axis central laser light are emitted to an area around the center of the recognition range 93 at which the target 100 is located, and the reflected lights of them are received. In the example of FIG. 12, the Y-axis central laser light is the fifth-face laser light and the laser lights on both sides of the Y-axis central laser light are the fourth and sixth-face laser lights.

In Step 60, the light-receiving intensities of the reflected lights of the laser lights on both sides of the Y-axis central laser light are measured. In the measurement, an average light-receiving intensity obtained by averaging the light-receiving intensities of a plurality of laser lights or the light-receiving intensity of a single laser light may be used.

In Step 70, the deviation angle Δθelv of the angle of the center of the Y-axis central laser light from the reference angle ΔA is calculated based on the thus measured light-receiving intensity. In the example of FIG. 12, the deviation angle Δθelv of the angle of the center of the fifth-face laser light as the Y-axis central laser light from the reference angle ΔA is calculated based on the light-receiving intensities of the reflected lights of the fourth and sixth-face laser lights. More specifically, in the case where the ratio of the light-receiving intensity of the fourth-face laser light to that of the sixth-face laser light is 3:1, the deviation angle Δθelv is calculated by (divergence angle 1.57 deg−overlapping range 0.145×2)×3/(3+1)−0.64 deg=0.32 deg. Thus, it can be calculated that the angle of the center of the fifth-face laser light is deviated toward the fourth-face laser light by 0.32 deg.

0.64 deg in the above calculation is equal to ½ of the value obtained by subtracting the overlapping range 0.145×2 from the divergence angle 1.57 deg. That is, the deviation angle Δθelv of the angle of the center of the fifth-face laser light from the reference angle ΔA can be obtained by subtracting the angle of the center of the fifth-face laser light from the reference angle ΔA that is estimated from the ratio of the light-receiving intensity between the fourth and sixth-face laser light.

In the case where the reference angle ΔA is deviated from the center of the fifth-face laser light toward the fourth-face laser light, the optical axis of the laser radar sensor 5 is downward. Thus, in this case, the deviation angle Δθelv is represented with a minus sign (−). When the reference angle ΔA is deviated toward the sixth-face laser light, the optical axis of the laser radar sensor 5 is upward. In this case, the deviation angle Δθelv is represented with a plus sign (+).

The calculation method of the deviation angle Δθelv from the reference angle ΔA is not limited to the above. For example, a difference between the light-receiving intensities of the fourth and sixth-face laser lights may be obtained, and thereafter the deviation angle Δθelv may be obtained in accordance with the thus obtained difference. Alternatively, angles of the fourth and sixth-face laser lights in accordance with the light-receiving intensities may be obtained by regarding the light-receiving intensity of the fifth-face laser light as the Y-axis central laser light as reference, and thereafter the deviation angle Δθelv may be obtained by subtraction using the thus obtained angles.

Under normal conditions, it is ideal that the target 100 is placed so as to make the angle of the center of the divergence angle of the fifth-face laser light in Y-axis direction coincident with the reference angle ΔA. However, because the divergence angle of the Y-axis laser light is large, the change of the position of the target 100 within the divergence angle cannot be detected. Thus, the light-receiving intensities of the laser lights emitted on both sides of the Y-axis central laser light are used, as described above, thereby the optical center of the laser light in the vertical direction can be calculated more finely. The deviation angle Δθelv of the angle of the center of the divergence angle of the Y-axis central laser light from the reference angle ΔA is stored as a vertical optical axis learning angle.

By obtaining the vertical optical axis learning angle Δθelv (deviation angle) in the above manner, it is possible to more precisely recognize an object such as a leading vehicle, as described later.

When the laser radar sensor 5 recognizes an object in front of the present vehicle after the recognition range 93 was set in the aforementioned manner, the laser radar CPU 70 two-dimensionally scans the recognition range 93 with laser light. Scanning angles θx and θy that indicate the scanning direction and a measured distance r are obtained from the above two-dimensional scanning. The vertical scanning angle θy is defined as an angle formed between a line obtained by projecting the emitted laser beam onto Y-Z plane and Z-axis. The horizontal scanning angle θx is defined as an angle formed between a line obtained by projecting the emitted laser beam onto X-Z plane and Z-axis.

The laser radar CPU 70 calculates the distance from the object from the time difference ΔT between two pulses PA and PB input from the time measuring circuit 89, and creates position data based on the thus calculated distance and the corresponding scanning angles θx and θy. That is, the laser radar CPU 70 converts the distance and the scanning angles θx and θy to data of X-Y-Z orthogonal coordinates which assumes that the center of the laser radar is the origin (0, 0, 0), the vehicle-width direction is X-axis, the vehicle-height direction is Y-axis, and the forward direction from the vehicle is Z-axis. Then, the laser radar CPU 70 outputs the (X, Y, Z) data thus obtained and data of the light-receiving intensity (corresponding to the pulse width of the stop pulse PB) to the ECU for recognition and distance control 3 as measured distance data.

The ECU for recognition and distance control 3 recognizes the object based on the measured distance data from the laser radar sensor 5, and performs so-called distance control for controlling the speed of the present vehicle by outputting driving signals to the brake driving unit 19, the throttle driving unit 21, and the automatic transmission controller 23 in accordance with a status of a leading vehicle. The status of the leading vehicle can be obtained from the recognized object. The ECU 3 simultaneously performs an alarm decision process for giving an alarm when the recognized object continues to exist within a predetermined alarm region, for example. The object described in this description is a moving or parked leading vehicle of the present vehicle, for example.

Next, the internal architecture of the ECU for recognition and distance control 3 is described as control brocks, with reference to FIG. 1. The measured distance data output from the laser radar sensor 5 is sent to an object recognition block 43. The object recognition block 43 obtains the position of the center of the object (X, Y, Z) and the size of the object such as the width, depth and height (W, D, H) based on the three-dimensional data obtained as the measured distance data. The object recognition block 43 also obtains the relative velocity (Vx, Vy, Vz) of the object with respect to the position of the present vehicle based on the change of the position of the center of the object (X, Y, Z) with time. Moreover, the object recognition block 43 determines whether the object is a stopping object or a moving object from the speed of the present vehicle, that is output based on the detected value of the speed sensor 7 from a speed calculation block 47, and the aforementioned relative velocity of the object (Vx, Vy, Vz). Then, the object that affects on the driving of the present vehicle is selected based on the above determination result and the position of the center of the object. A distance indicator 15 indicates the distance from the selected object.

A steering angle calculation block 49 obtains a steering angle based on a signal from the steering sensor 27. A yaw rate calculation block 51 calculates a yaw rate based on a signal from the yaw rate sensor 28. A curve radius (radius of curvature) calculation block 57 calculates a curve radius (radius of curvature) R based on the speed from the speed calculation block 47, the steering angle from the steering angle calculation block 49, and the yaw rate from the yaw rate calculation block 51. Then, the object recognition block 43 calculates vehicle's shape probability and the same-lane probability based on the curve radius R of the object, the coordinates of the position of the center of the object (X, Y, Z), and the like. The vehicle's shape probability is probability that the object has a vehicle's shape and the same-lane probability is probability that the object is in the same lane as the present vehicle. Those probabilities are described later.

A model of the object having the above data is called as a “target model.” A sensor trouble detection block 44 detects whether the data obtained by the object recognition block 43 is normal or abnormal. When that data is abnormal, the sensor trouble indicator 17 indicates that fact.

A leading vehicle determination block 53 selects a leading vehicle based on the various kinds of data obtained from the object recognition block 43 and obtains the distance Z from the selected vehicle and the relative velocity Vz thereof. Then, a distance control and alarm decision block 55 decides whether to give an alarm or not in the case of alarm decision and decides the details of the speed control in the case of cruise decision, based on the aforementioned distance Z and relative velocity Vz, a setting condition of the cruise control switch 26, a pressing condition of the brake switch 9, an opening angle from the throttle opening angle sensor 11, and a sensitivity value set by the alarm sensitivity setting unit 25. The distance control and alarm decision block 55 then outputs an alarm giving signal to the alarm sounder 13 in the case where the alarm should be given. In the case of the cruise decision, the distance control and alarm decision block 55 outputs control signals to the automatic transmission controller 23, the brake driving unit 19, and the throttle driving unit 21, thereby performing required control. During that control, the distance control and alarm decision block 55 outputs a necessary indication signal to the distance indicator 15 so as to let the driver know the situation.

When the control of the distance between vehicles or the alarm decision is performed, it is important that object recognition as a basis for the distance control or alarm decision, i.e., recognition of a vehicle is appropriately performed. Therefore, the object recognition block 43 of the ECU for recognition and distance control 3 performs a process related to object recognition for achieving the appropriate vehicle recognition. This process is now described.

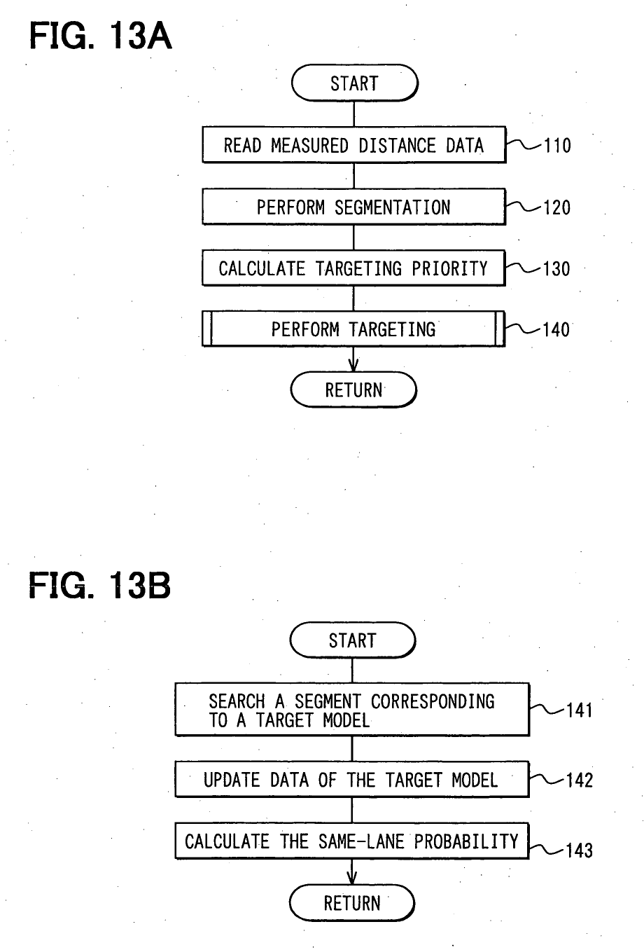

FIG. 13A is a flowchart of a main process of the object recognition. In Step 110, the measured distance data of one scan is read from the laser radar sensor 5. The period of the scanning by the laser radar sensor 5 is 100 msec, for example. The measured distance data is read every 100 msec.

In Step 120, the data is segmented. More specifically, the three-dimensional position data obtained as the measured distance data, as described above, is grouped to form segments. In this segmentation, data units that satisfy a predetermined junction condition (integrating condition) are collected to create one pre-segment. Then, one or more pre-segments that satisfy a predetermined junction condition (integrating condition) are collected to create one main segment. For example, in the case where each data unit of the three-dimensional data corresponds to one point, when a distance between points in X-axis direction ΔX is 0.2 m or less and that in Z-axis direction ΔZ is 2 m or less, data units corresponding to those points are combined into one pre-segment. In the present embodiment, there are three scanning lines in Y-axis direction, and a pre-segment is created for each scanning line. Therefore, in the main segmentation, the pre-segments that are close to each other in the three-dimensional (X, Y, Z) space are combined into one main segment. The data of the main segment represents a region of a rectangular solid having three sides that are parallel to X-axis, Y-axis, and Z-axis, respectively, and contains the coordinate of the center of that region (X, Y, Z) and the length of the three sides (W, D, H) for indicating the size of that region. Please note that the main segmentation and the data of the main segment are simply called as segmentation and segment data unless specifically described.

In Step 130, each segment is regarded as a pre-target and targeting priority is calculated for each pre-target. The targeting priority represents probability that the pre-target is subjected to a targeting process as a target model. The target model is an object model created for a cluster of segments, for which the targeting process is performed. The pre-target is a candidate of the target model. In the present embodiment, up to 18 pre-targets can be selected, and four of those pre-targets are further selected as target models in descending order of the targeting priorities.

The targeting priority of each pre-target is calculated by determining whether or not the vehicle's shape probability is higher than a predetermined probability (e.g., 50%), whether the pre-target is moving or not, whether or not the pre-target exists within a predetermined distance (e.g., 6 m on each of the right and left sides) from the present vehicle in the lateral direction (the vehicle-width direction), and whether or not the detection of the pre-target continues for a predetermined time or longer, for example. The targeting priority becomes higher as the number of positive results of the above determination factors increases.

Next, the vehicle's shape probability is described.

In the case where a number of delineators are arranged at small intervals by the roadside or a case where a guardrail is detected, such objects may be recognized as moving objects although they are not moving. This is because the object recognition device always detects something at the same position and therefore determines that there is a vehicle driving at the same speed as the present vehicle at that position. Thus, in order to prevent the object that was wrongly recognized as a moving object from being determined as a leading vehicle, the vehicle's shape probability is calculated. When the vehicle's shape probability is lower than 50%, for example, the leading vehicle determination block 53 determines the recognized object as something arranged by the roadside. Thus, it is possible to prevent a stopping object that repeatedly appears from being determined as a leading vehicle.

The vehicle's shape probability is in a range from 0 to 100%, and is calculated as a weighted average value as represented by Expression 1 provided below in order to reduce effects of instantaneous noises and variations.
Current vehicle's shape probability←previous vehicle's shape probability×α+current instantaneous value×(1−α) (Expression 1)

The initial value is 50% and α is 0.8, for example. The instantaneous value of the vehicle's shape probability is calculated based on the relative acceleration, the lengths D and W of the object in the vehicle-length direction and vehicle-width direction, the duration of detection, and the like. The calculation method of the vehicle's shape probability is described in detail in Japanese Patent Laid-Open Publication No. 2002-40139, [0045] to [0049], and therefore the further description thereof is omitted here.

In Step 140, four pre-targets that have the highest four targeting priorities are selected as target models. A targeting process is performed for each target model. The targeting process is described with reference to a flowchart of FIG. 13B. First, a segment corresponding to the target model is searched (Step 141). This process searches which one of the segments currently detected is coincident with the target model obtained before. The segment corresponding to the target model is defined as follows. First, the current position of the target model is estimated, assuming that the target model moved from the position in the previous process at the relative velocity in the previous process. Then, an estimated moving range is set around the thus estimated current position to have a predetermined width in each of X, Y, and Z-axis directions. A segment that is at least partially contained in the estimated moving range is defined as the segment corresponding to the target model.

In Step 142, a data update process for updating the data of the target model is performed. This process updates the previous data of the target model based on the current data, if there is a segment corresponding to the target model. The data to be updated contains the coordinate of the center of the target model (X, Y, Z), the width W, the height H, the depth D, the relative velocities in X, Y, and Z-axis directions (Vx, Vy, Vz), the coordinate of the center (X, Y, Z) in the last four updates, the same-lane probability, and the like. If there is no segment corresponding to the target model, the data of the target model is not updated. Instead, a new target model is registered.

In Step 143, the same-lane probability is calculated. The same-lane probability is a parameter of likelihood that the target model is a vehicle driving in the same lane as the present vehicle. First, the position of the target model is calculated. Then, the calculated position is superimposed on a map of the same-lane probability, thereby obtaining an instantaneous value of the same-lane probability of the target model. The map of the same-lane probability is a map in a predetermined range (having a size of 5 m on each of the right and left sides and 100 m in the forward direction, for example) in front of the present vehicle and is divided into a plurality of areas. Each of the areas has probability in such a manner that the probability becomes higher as the area is closer to the present vehicle or the course of the present vehicle.

After the instantaneous value of the same-lane probability was obtained, the same-lane probability is obtained as a weighted average value as represented by Expression 2 provided below.
The same-lane probability←the previous same-lane probability×α+the instantaneous value of the same-lane probability×(1−α) (Expression 2)

In Expression 2, a may be a constant value or a variable that depends on the distance from the target model or the area in which the target model exists. The calculation method of the same-lane probability is also described in detail in Japanese Patent Laid-Open Publication No. 2002-40139, paragraphs [0050] to [0056] and, therefore, the further description thereof is omitted here.

Then, the object recognition block 43 outputs the data of the target model, containing the vehicle's shape probability and the same-lane probability, to the leading vehicle determination block 53, as shown in FIG. 1. The leading vehicle determination block 53 selects one from the target models each having the vehicle's shape probability equal to or larger than a predetermined threshold value (e.g., 50%) and the same-lane probability equal to or larger than a predetermined threshold value (e.g., 50%), that has the shortest distance Z from the present vehicle, and determines the selected target model as a leading vehicle of the present vehicle. This determination result is output to the distance control and alarm determination block 55.

Next, a process for learning the optical center of the laser radar sensor 5 is described.

Even in the case where the irradiation angle of the central laser light of the recognition range 93 of the laser radar sensor 5 is set to be coincident with the reference angle ΔA by using the target 100, the actual radiation range of the laser light is changed by various factors. For example, the shipping state of the present vehicle, the number of passengers, and the like may deviate the irradiation range of the laser light of the laser radar sensor 5 from the recognition range 93. In addition, when drive of the vehicle is repeated, an attaching state of the laser radar sensor 5 may be changed by effects of vibration during driving and the like. The change of the irradiation angle of the laser light easily occurs especially in Y-axis direction, as described above. Therefore, it is preferable to determine whether the vertical optical axis learning angle Δθelv calculated based on the target 100 in the aforementioned manner is deviated or not and to perform correction when vertical optical axis learning angle is deviated.

In the present embodiment, the learning of the optical center of the laser radar sensor 5 is performed using a reflector that must be attached to a passenger car. This is because the reflector of the passenger car is arranged at a level of about 75 cm above the ground and the arranging level is not largely varied between different car types.

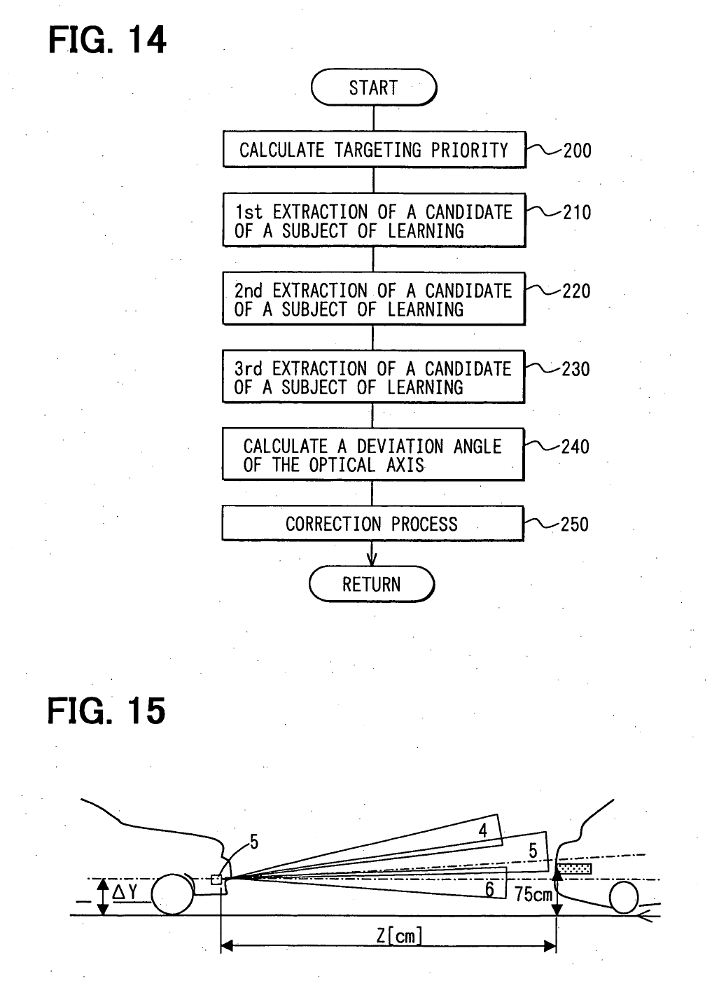

FIG. 14 is a flowchart of the process for learning the optical center of the laser radar sensor 5. In Step 200, the targeting priority is calculated for each of a plurality of pre-targets. The calculation method is basically the same as that described in Step 130 of the flowchart of FIG. 1 3A.

However, in this learning process, a pre-target corresponding to a vehicle and a pre-target corresponding to an object other than a vehicle are distinguished from each other by using the vertical optical axis learning angle Δθelv described above. Then, the targeting priority of the pre-target corresponding to an object other than a vehicle is limited to a predetermined low probability (e.g., 20%). The distinguishing method using the vertical optical axis learning angle Δθelv is now described. This distinguishing method may be applied to Step 130 of the flowchart of FIG. 1 3A so as to limit the targeting priority of the pre-target for an object other than a vehicle to a predetermined low probability.

First, the vertical optical axis learning angle Δθelv is compared with an upward determining angle (e.g., +0.5 deg) and a downward determining angle (e.g., −0.5 deg), thereby determining whether the orientation of the optical axis is upward or downward. In other words, when the vertical optical axis learning angle Δθelv is +0.5 deg or larger, the orientation of the optical axis is determined to be upward. When the vertical optical axis learning angle Δθelv is −0.5 deg or smaller, the orientation of the optical axis is determined to be downward.

In the case where the orientation of the optical axis is upward, the targeting priority of the pre-target for which the following condition (1) or (2) is established is limited to a predetermined small value. The following conditions are described with reference to the example shown in FIG. 11, if necessary.

(1) In the case where only the reflected light of the laser light emitted on the lower side of the Y-axis central laser light is received, and Z (cm)>ΔY (cm)×40+D (cm) is satisfied where Z is the distance from the pre-target and AY represents the attaching level.

In the present embodiment, the divergence angle of the laser light in Y-axis direction is 1.57 deg and tan(1.57 deg) approximately equals to 1/37, as shown in FIG. 11. In addition, the divergence angle of the laser light on the lower side of the central laser light only, i.e., the divergence angle of the laser light except for the overlapping region is 1.57−0.145=1.425 deg, and tan(1.425 deg) approximately equals to 1/40.

Please note that the laser light (sixth-face laser light) on the lower side of the Y-axis central laser light is emitted below the horizontal level in principle. However, when the orientation of the optical axis is determined to be upward, the upper end of the sixth-face laser light may be approximately horizontal. Even in this case, when the distance Z from the pre-target satisfies the above relationship, at least the lower end of the sixth-face laser light reaches the road surface. Moreover, the pre-target reflects only the sixth-face laser light but does not reflect the fifth-face laser light that is the Y-axis central laser light. Thus, it is estimated that the pre-target is located on the road surface or at a position very close to the road surface. Therefore, the pre-target is estimated as an object other than a vehicle, such as a delineator.

In the above relationship, D (cm) is a value of margin set considering an error of distance measurement, the road grade, and the like. For example, D is set to 500 (cm).

(2) In the case where only the reflected light of the laser light emitted on the upper side of the Y-axis central laser light is received or both the reflected lights of the Y-axis central laser light and the laser light on the upper side thereof are received, and Z (cm)>(350 (cm)×ΔY (cm))×37+D (cm) is satisfied.

When the orientation of the optical axis is determined to be upward, the lower end of the Y-axis central laser light may be approximately horizontal, as described above. Therefore, in the example of FIG. 11, the fifth-face laser light and the fourth-face laser light, that are the Y-axis central laser light and the laser light on the upper side thereof, broaden upward. There are a number of objects such as road signs and other signs arranged above the road. Thus, the fourth and fifth-face laser lights broadening upward can be easily reflected from those objects. The above condition (2) is established when light reflected from such an object above the road may be received.

The maximum height of a vehicle is about 350 (cm), even if that vehicle is a high vehicle such as a truck. Thus, in the case where the reflected lights of the fourth and fifth-face laser lights from the pre-target are received and the distance Z from that pre-target is longer than a distance at which the irradiation level of the fifth-face laser light (Y-axis central laser light) above the road exceeds 350 (cm), it is likely that the reflected lights that are received are reflected from an object other than a vehicle. Therefore, the targeting priority of that pre-target is limited to be low. This description can be also applied to a case where only the reflected light of the fourth-face laser light is received.

Next, a case where the orientation of the optical axis is determined to be downward is described. In this case, when the following condition (3) or (4) is established for a pre-target, the targeting priority of that pre-target is limited to a predetermined low probability.

(3) In the case where only the reflected light of the laser light emitted on the lower side of the Y-axis central laser light is received or both the reflected lights of the Y-axis central laser light and the laser light on the lower side thereof are received, and Z (cm)>ΔY (cm)×37+D (cm) is satisfied.

When the orientation of the optical axis is determined to be downward, the upper end of the Y-axis central laser light may be approximately horizontal, contrary to a case where the orientation of the optical axis is determined to be upward. Thus, in the example of FIG. 11, the fifth and sixth-face laser light, that are the Y-axis central laser light and the laser light emitted on the lower side thereof, broaden downward and can be easily reflected from an object on the road surface or at a low level above the road surface. The above condition (3) is established in the case where the reflected light from the object on the road surface or at a low level above the road surface may be received.

Because the divergence angle of the laser light is 1.57 deg, as described above, a distance at which the fifth-face laser light as the Y-axis central laser light approximately reaches the road surface can be calculated by multiplying tan(1.57 deg) by the attaching level ΔY of the laser radar sensor 5. When the distance Z from the pre-target is longer than a distance obtained by adding margin D (cm) to the thus calculated distance and both the reflected lights of the fifth and sixth-face laser lights or only the reflected light of the sixth-face laser light are/is received, the reflection occurs at a very low level above the road. Therefore, the targeting priority of that pre-target is limited to be low in this case.

(4) In the case where the reflected light of only the laser light emitted on the upper side of the Y-axis central laser light is received and Z (cm)>(350 (cm)−ΔY (cm))×40+D (cm) is satisfied.

When the orientation of the optical axis is determined to be downward, the laser light (fourth-face laser light) on the upper side of the Y-axis central laser light is emitted above the horizontal level toward a direction relatively close to the horizontal direction. Even in this case, when the distance Z from the pre-target satisfies the above relationship, at least the upper end of the fourth-face laser light reaches a level equal to the maximum vehicle's height. In addition, because the fourth-face laser light is reflected from the pre-target whereas the fifth-face laser light as the Y-axis central laser light is not reflected, it is estimated that the pre-target is located at a very high level above the road. Therefore, when the condition (4) is established, it is estimated that the pre-target may be an object other than a vehicle, such as a road sign or another sign.

Moreover, the targeting priority of the pre-target may be also limited to be low when the following condition is established in addition to the aforementioned conditions (1) to (4).

(5) In the case where an angle Δθ between the lower end of the fifth-face laser light and the horizontal level is equal to or larger than a predetermined angle E, as shown in FIG. 11, the distance from the pre-target is equal to a shorter than a predetermined short distance 1 (e.g., 30 m), the width of the pre-target is equal to or smaller than the width of a vehicle (e.g., 0.5 m), and only the reflected light of the sixth-face laser light is received.

The method for setting the predetermined angle Θ is described. First, a reference irradiation height h of the lower end of the fifth-face laser light as the Y-axis central laser light at the predetermined short distance 1 is determined (e.g., 30 cm above the ground). The angle Θ is calculated based on the reference irradiation height h by Expression 3.
Θ=tan⁻¹(ΔY−h)/1 (Expression 3)

When the angle Δθ of the lower end of the fifth-face laser light with respect to the horizontal level is equal to or larger than the thus set angle Θ, the reference irradiation height h is set to a relatively low level above the ground, as described above. Therefore, the irradiation range of the fifth-face laser light can cover an object having a height of 30 cm above the ground within the distance 1 from the laser radar sensor 5. In other words, when reflection of only the sixth-face laser light occurs within the distance 1 from the laser radar sensor 5, the height of an object reflecting the sixth-face laser light is the reference irradiation height h at the highest.

If the reflecting object is a vehicle and gets within the predetermined short distance from the laser radar sensor 5, that object must have the height higher than the reference irradiation height h and reflect the fifth-face laser light.

Therefore, when the above condition (5) is established, the reflecting object (pre-target) can be estimated to be an object other than a vehicle, such as a delineator. Thus, the targeting priority of that pre-target is limited to a predetermined low probability.

In the above condition (5), one of the requirements of the establishment of the condition (5) is that the width of the pre-target is a predetermined width or less. This requirement is for confirmation and can be omitted.

After the targeting priority of each pre-target is calculated in the aforementioned manner, the first extraction of a candidate of a subject of learning is performed in Step 210 of the flowchart of FIG. 14. In the first extraction, among the pre-targets that are continuously recognized as moving objects for a predetermined period (e.g., 5 seconds) or longer and have the vehicle's shape probability of 50% or higher, one having the highest targeting priority is extracted as the candidate of learning subject. Therefore, it is very unlikely that the pre-targets for which the above conditions (1) to (5) are established are selected as the candidates of the subject of learning, because the targeting priorities of those pre-targets are suppressed to be low.

In Step 220, the second extraction of the candidate of the subject of learning is performed. In the second extraction, it is determined whether or not a state in which a lateral relative velocity (i.e., the relative velocity in the vehicle-width direction) Vx of the candidate of the subject of learning selected by the first extraction with respect to the present vehicle is equal to or smaller than a predetermined velocity (e.g., 0.2 m/s) and a relative velocity of that candidate in the traveling direction Vz is a predetermined velocity (e.g., 0.1 m/s) or less continues for a predetermined period. In other words, it is determined whether or not a relationship of relative positions between the candidate of the subject of learning and the present vehicle is substantially stable. This is because an error of measuring the distance from the candidate of the subject of learning is small in the aforementioned state. If a state in which both the lateral relative velocity Vx and the relative velocity in the traveling direction Vz are a predetermined velocity (e.g., 0.1 m/s) or less continues for a predetermined period, the candidate is then extracted as a candidate selected by the second extraction.

In Step 230, the third extraction of the candidate of the subject of learning is performed. In the third extraction, it is determined whether or not the width of the candidate of the subject of learning extracted in the second extraction falls within a predetermined range (e.g., a range from 1.2 m to 2.1 m) and the distance Z from that candidate falls within a predetermined range (e.g., a range from 30 m to 80 m).

The reason for determining the width of the candidate of the subject of learning in the present embodiment is to select a passenger car in which a reflector is attached to the substantially same level as the candidate of the subject of learning. In addition, the reason for determining the distance Z from the candidate is that, when the distance Z becomes too short, the light-receiving intensity of the light reflected from the body of the passenger car other than the reflector becomes high and recognition of the reflector becomes more difficult and, when the distance Z becomes too long, the light-receiving state is unstable. That is, when the distance Z is too short or too long, wrong learning may occur.

When both the width and distance Z were determined to fall within the predetermined ranges, respectively, that candidate is selected as the candidate of the subject of learning by the third extraction. An instantaneous value θu of a vertical optical axis deviation angle is then calculated using the candidate of the subject of learning selected through the first, second, and third extractions in Step 240. An expression for calculating the instantaneous value θu of the vertical optical axis deviation angle is shown as Expression 4.
θu[LSB=0.01 deg]=(detected face number by the reflector−5)×1.425[deg]×−A[deg]+tan⁻¹(75 [cm]×−Y [cm])/Z [cm] (Expression 4)

The detected face number by the reflector in Expression 4 is the face number of the laser light that is reflected from the reflector provided on the passenger car that is the candidate of the subject of learning. In the present embodiment, the detected face number by the reflector is 4 (the upper face of the reflector), 4.5 (the intermediate part between the upper and middle faces), 5 (the middle face), 5.5 (the intermediate part between the middle and lower faces), or 6 (the lower face). In the example of FIG. 15, the detected face number by the reflector is 5.5 (the intermediate part between the middle and lower faces).

The instantaneous value θu of the vertical optical axis deviation angle represents the magnitude of the deviation of the angle of the center of the divergence angle of the fifth-face laser light as the Y-axis central laser light from the reference angle ΔA as the target of the center of the divergence angle of the fifth-face laser light. The instantaneous angle θu can be calculated by Expression 4.

It is then determined whether or not the instantaneous value θu of the vertical optical axis deviation angle calculated by Expression 4 falls within a range of ±1.424 deg, for example, thereby determining whether that instantaneous value θu is normal or abnormal. When the instantaneous value θu was determined to be abnormal, it is regarded that the instantaneous value θu is not calculated.

When the instantaneous value θu was determined to be normal, the number of calculations Nu of the instantaneous value θu is incremented by one as represented by Expression 5, and summation of the instantaneous values θu is calculated as represented by Expression 6.

$$\begin{matrix}Nu = Nu + 1 & ( Expression 5 ) \\ {\sum }^{Nu} θ u = {\sum }^{Nu} θ u + θ u & ( Expression 6 )\end{matrix}$$

Moreover, when the number of calculations Nu of the instantaneous value θu of the vertical optical axis deviation angle has reached a predetermined number (e.g., 200), an average value θuave of the instantaneous value θu is calculated as represented by Expression 7.

$$θ uave = {\sum }^{Nu} θ u \div Nu \qquad ( Expression 7 )$$

With the calculation of θuave, the number of calculations Nu and the summation Σθu are initialized to zero, respectively.

In Step 250, the vertical optical axis learning angle Δθelv is corrected based on the average value θuave of the instantaneous value θu of the vertical optical axis deviation angle. More specifically, in order to prevent sharp change of the vertical optical axis learning angle Δθelv, a value obtained by adding 0.05 deg to the vertical optical axis learning angle Δθelv, a value obtained by subtracting 0.05 deg from the vertical optical axis learning angle Δθelv, and the average value θuave are compared. When the average value θuave was determined to be larger than the value obtained by adding 0.05 deg, 0.05 deg is added to the vertical optical axis learning angle Δθelv. When the average value θuave was determined to be smaller than the value obtained by subtracting 0.05 deg, 0.05 deg is subtracted from the vertical optical axis learning angle Δθelv. In this manner, the vertical optical axis learning angle Δθelv is corrected while the change amount thereof is limited to a predetermined angle (0.05 deg).

Thus, it is possible to appropriately correct the irradiation angle of the laser light of the laser radar sensor 5 even in the case where that irradiation angle is deviated from the initially set angle (the vertical optical axis learning angle Δθelv) especially in Y-axis (vertical) direction due to reasons of the shipping state of the present vehicle, the number of passengers, and the like.

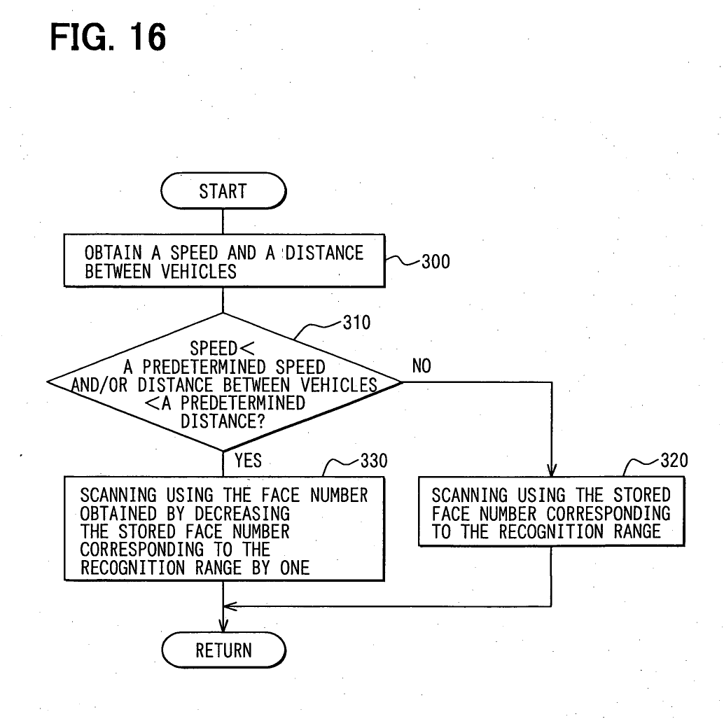

Next, features of the present invention are described. In the present embodiment, when the vehicle control device is actually used, the recognition range 93 that was set in the aforementioned manner is switched in accordance with the speed of the present vehicle or the distance between the present vehicle and a leading vehicle. The switching is achieved by performing a recognition range switching process. The laser radar CPU 70 performs the recognition range switching process. The switching of the recognition range 93 is described with reference to FIG. 16. FIG. 16 is a flowchart of the recognition-range switching process.

In Step 300 in FIG. 16, the speed and the distance between the vehicles are obtained. The speed is calculated by the speed calculation block 47 based on the detection signal from the speed sensor 7. The laser radar CPU 70 obtains the thus calculated speed from the ECU for recognition and distance control 3. The distance between the vehicles means a distance between the present vehicle and one of the objects for which the laser radar CPU 70 performed the distance measurement, which was determined as a leading vehicle by the leading vehicle determination block 53 (i.e., the distance Z). The laser radar CPU 70 obtains the measured distance data of the object determined as the leading vehicle from the ECU for recognition and distance control 3.

In Step 310, it is determined whether or not the present vehicle is in at least one of a low-speed state and a short-distance state. In the low-speed state, the speed of the present vehicle obtained in Step 300 is lower than a predetermined speed (e.g., 30 km/h). In the short-distance state, the distance between the present vehicle and the leading vehicle is shorter than a predetermined distance (e.g., 30 m). When the present vehicle is in the low-speed state because it is in slow traffic, for example, the distance between the present vehicle and the leading vehicle easily becomes short. Thus, in the case where the leading vehicle is a high vehicle such as a truck, the laser light may suddenly go off the reflector of the leading vehicle to make the distance detection inoperative. Moreover, when the present vehicle is in the short-distance state, that is, the distance between the vehicles that was actually measured is short, the distance detection may become inoperative for the similar reason.

Thus, if No in Step 310, the present vehicle is in neither the low-speed state nor the short-distance state. Therefore, the switching of the recognition range 93 is not needed and the process goes to Step 320. In this case, the scanning using the side faces of the face numbers that are stored in the laser radar CPU 70 as those corresponding to the recognition range 93, i.e., the scanning using the fourth, fifth and sixth side faces of the polygon mirror 73 in the present embodiment is maintained in Step 320. Thus, the laser light is emitted from the laser diode 75 when the fourth, fifth, and sixth side faces of the polygon mirror 73 look forward of the present vehicle, so that the laser light is emitted forward of the present vehicle at an angle depending on the angles of the fourth, fifth, and sixth side faces with respect to the bottom face of the polygon mirror 73.

If Yes in Step 310, the process goes to Step 330 and the recognition range 93 is switched.

More specifically, in Step 330, the scanning is performed using the side faces of the face numbers obtained by decreasing the face numbers stored as those corresponding to the recognition range 93 in the laser radar CPU 70 by one. In the case where the laser radar CPU 70 stores 4, 5, and 6 as the face numbers corresponding to the recognition range 93, as in the present embodiment, for example, the side faces of the face numbers obtained by decreasing the stored face numbers by one, i.e., the third, fourth, and fifth side faces are used for the scanning.

Thus, in this case, the laser light is emitted from the laser diode 75 when the third, fourth, and fifth side faces of the polygon mirror 73 look forward of the present vehicle, so that the laser light is emitted forward of the present vehicle at an angle depending on the angles of the third, fourth, and fifth side faces with respect to the bottom face of the polygon mirror 73.

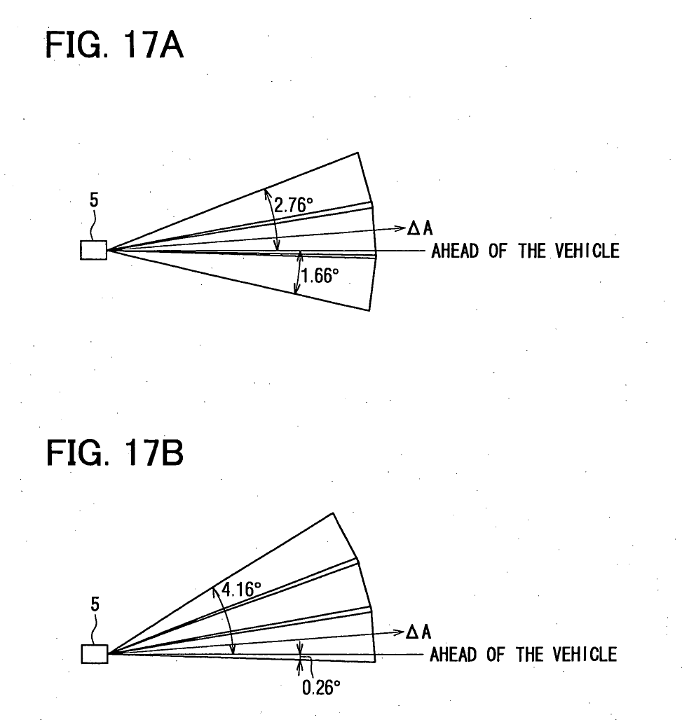

The irradiation angle of the laser light in the case where no switching of the recognition range 93 was performed and a case where the switching was performed is shown in FIGS. 17A and 17B, respectively.

In the case where no switching of the recognition range 93 was performed, as shown in FIG. 17A, the laser light reflected from the fourth, fifth, and sixth side faces of the polygon mirror 73 is used. In other words, during normal driving, the fifth laser light containing the reference angle ΔA is used as the Y-axis central laser light so as to deal with a case where a distant object has to be detected during high-speed driving, for example. In addition, the fourth and sixth laser lights on both sides of the Y-axis central laser light are also included in the recognition range 93, considering a possible change of the irradiation angle of the Y-axis central laser light because of pitching movement of the present vehicle caused by roughness of the road.

On the other hand, in the case where the recognition range 93 was switched, as shown in FIG. 17B, the laser light reflected from the third, fourth, and fifth faces of the polygon mirror 73 is used. In other words, while at least the fifth laser light containing the reference angle ΔA is emitted forward of the present vehicle, the third and fourth laser lights are included in the recognition range 93 after the switching so as to irradiate positions higher than the recognition range 93 before the switching, i.e., the recognition range 93 set for normal driving with the laser light, considering a case where the distance between the present vehicle and a truck or the like in front and becomes shorter and the laser light goes off the reflector.

When the low-speed or short-distance state is eliminated after the side faces corresponding to the recognition range 93 were switched to the third, fourth, and fifth side faces in the low-speed or short-distance state, the process goes to Step 320 again. In this case, in order to change the recognition range 93 in the low-speed or short-distance state to that for normal driving, the face numbers in the low-speed or short-distance state are switched to the face numbers corresponding to the recognition range 93 for normal driving that are stored in the laser radar CPU 70.

As described above, in the present embodiment, the laser light is emitted to a higher level in the case where the low-speed or short-distance state was detected, as compared with a case of normal driving. Thus, even if the present vehicle comes close to a truck or the like, the laser light can be emitted to a higher level so as to be incident on the reflector arranged at a high position on the truck or the like.

Therefore, it is possible to prevent occurrence of a situation in which the laser light goes off the reflector and the distance detection suddenly becomes inoperative because of the short distance between the present vehicle and the truck or the like.

In addition, the upward emission of the laser light in the aforementioned manner is achieved by software means without modification to the conventional mechanical structure of the laser radar sensor 5. Therefore, the aforementioned effects can be achieved by using the laser radar sensor 5 having the conventional structure as it is.

In the present embodiment, the attaching angle of the laser radar sensor 5 is roughly adjusted by mechanical adjustment and is then finely adjusted by software adjustment. As a result of those adjustments, the face numbers 4, 5 and 6 are stored as the face numbers of the side faces of the polygon mirror 73 that correspond to the recognition range 93, for example. However, in the case where the first, second, and third side faces of the polygon mirror 73 are determined to correspond to the recognition range 93, it is impossible to emit the laser light to an upper level than the level of the first-face laser light. Therefore, the mechanical adjustment has to be performed to such an extent that at least three side faces from the second, third, fourth, fifth, and sixth faces are selected as the side faces corresponding to at least the recognition range 93. The mechanical adjustment to the above extent does not require troublesome work. Thus, the working time does not increase.

The present invention is not limited to the above embodiment. The present invention can be implemented in various embodiments within a range of the summary of the present invention.

(1) The above embodiment described a case where the emitting direction of the laser light is shifted downward as the face number increases. Therefore, in the low-speed or short-distance state, the face numbers obtained by decreasing the face numbers stored as those corresponding to the recognition range 93 in the laser radar CPU 70 by one, respectively, are used.

However, the side faces may be numbered in such a manner that the emitting direction of the laser light is shifted upward as the face number increases. For example, the relationship between the face numbers and the irradiation level of the laser light is reversed between a case where the laser radar sensor 5 is attached to a vehicle in such a manner that the side faces of the polygon mirror 73 look upward (normal mounting) and a case where the laser radar sensor 5 is attached to a vehicle in such a manner that the side faces of the polygon mirror 73 look downward (reverse mounting).

In this case, it is possible to emit the laser light to a higher level in the low-speed or short-distance state than the level during normal driving by using the side faces of the face numbers obtained by increasing the face numbers stored as those corresponding to the recognition range 93 in the laser radar CPU 70 by one.

(2) In the above embodiment, the face numbers are decreased or increased in the low-speed or short-distance state by one from the face numbers stored in the laser radar CPU 70 as those corresponding to the recognition range 93. However, any face number is used in the low-speed or short-distance state, as long as the recognition range 93 is switched to correspond to the face numbers of the side faces that can emit the laser light to a higher level than the level of the laser light emitted by the side face of the face number set for the recognition range 93 of normal driving.

Although the scanning using the face number of the laser light containing the reference angle ΔA is performed in the low-speed or short-distance state, the laser light for the scanning does not always contain the reference angle ΔA. However, it is preferable to perform the scanning using the face number of the light containing the reference angle ΔA in order to enable detection of an object located at a relatively distant position even in the low-speed or short-distance state.

(3) In the above embodiment, the tolerance range of the attaching angle of the laser radar sensor 5 in each of X- and Y-axis directions is set to include margin, and the recognition range 93 is then set by using the target 100 in such a manner that the laser light having the highest light-receiving intensity in each of X and Y-axis directions is located on the center of the recognition range 93. However, the tolerance range of the attaching angle may be made narrower in one of X and Y-axis directions, whereas the recognition range 93 may be set by using the target 100 only in the other direction, for example. In this case, burden of the adjustment of the attaching angle of the laser radar sensor 5 can be reduced, as compared with the conventional technique.

(4) In the above embodiment, the polygon mirror 73 in which the side faces have different angles with respect to the bottom face is used in order to perform two-dimensional scanning with laser light. Alternatively, the two-dimensional scanning can be performed by using a galvano mirror that can perform scanning in the vehicle-width direction and a mechanism that can change the angle of the mirror face of the galvano mirror, for example. However, the use of the polygon mirror 73 is more advantageous because the two-dimensional scanning can be achieved only by rotating the polygon mirror 73.

(5) In the above embodiment, the distance and the corresponding scanning angles θx and θy are converted from the polar coordinate system to the XYZ orthogonal coordinate system inside the laser radar sensor 5. Alternatively, this conversion may be performed in the object recognition block 43.

(6) The above embodiment employs the laser radar sensor 5 using laser light. Alternatively, electric waves such as millimeter waves, ultrasonic waves, or the like may be used. Moreover, any scanning method can be employed, as long as it can measure the orientation in addition to the distance. In the case of using an FMCW radar or a Doppler radar with millimeter waves, for example, information on the distance between the present vehicle and the leading vehicle and information on the relative velocity of the leading vehicle can be obtained from reflection waves (received waves) at one time. Therefore, the process for calculating the relative velocity based on the information on the distance, that is required in the case of using laser light, is not needed.

The steps shown in the drawings correspond to means for performing various processes, respectively.

1. An object recognition device for a vehicle, comprising:
a radar unit for emitting transmission waves in a plurality of angular ranges in a vehicle-height direction and for receiving reflection waves of the transmission waves reflected from a reflecting object, the transmission waves being emitted in a recognition range that is set based on the plurality of angular ranges;
recognition range setting means for setting the recognition range and instructing the radar unit to emit the transmission waves in the recognition range;
recognition means for recognizing the reflecting object based on a result of emission and receipt by the radar unit;
speed detection means for detecting a speed of the vehicle; and
recognition range switching means for switching the recognition range to a new recognition range when the speed detected by the speed detection means is smaller than a predetermined speed, the new recognition range being based on the plurality of angular ranges and located higher in the vehicle-height direction than the previous recognition range.

2. The object recognition device according to claim 1, further comprising:
leading vehicle determination means for determining that the reflecting object recognized by the recognition means is a second vehicle located ahead of the vehicle and obtaining a distance to the second vehicle, wherein
the recognition range switching means switches the recognition range to a new recognition range when the distance to the second vehicle is shorter than a predetermined distance, the new recognition range being based on the plurality of angular ranges and located higher in the vehicle-height direction than the previous recognition range.

3. The object recognition device for a vehicle, comprising:
a radar unit for emitting transmission waves in a plurality of angular ranges in a vehicle-height direction and for receiving reflection waves of the transmission waves reflected from a reflecting object, the transmission waves being emitted in a recognition range that is set based on the plurality of angular ranges;
recognition range setting means for setting the recognition range and instructing the radar unit to emit the transmission waves in the recognition range;
recognition means for recognizing the reflecting object based on a result of emission and receiving by the radar unit;
leading vehicle determination means for determining that the reflecting object recognized by the recognition means is a second vehicle that is located ahead of the vehicle and obtaining a distance to the second vehicle; and
the recognition range switching means switches the recognition range to a new recognition range when the distance to the second vehicle is shorter than a predetermined distance, the new recognition range being based on the plurality of angular ranges and located higher in the vehicle-height direction than the previous recognition range.

4. The object recognition device according to claim 1, wherein
the radar unit includes a polygon mirror having a plurality of side faces that have different angles with respect to a bottom face, wherein the radar unit emits the transmission waves in the vehicle-height direction by reflecting the transmission waves by each of the side faces of the polygon mirror,
the recognition range setting means stores face numbers assigned to the side faces of the polygon mirror in accordance with the different angles and causes the transmission waves to be emitted in the recognition range by reflecting the transmission waves with side faces having face numbers corresponding to the recognized range, and
the recognition range switching means sets new face numbers of the side faces to a higher level in the vehicle-height direction than the side faces of the face numbers stored in the recognition range setting means and causes each of the side faces of the new face numbers of the polygon mirror to reflect the transmission waves, the new face numbers corresponding to the new recognition range.

5. The object recognition device according to claim 3, wherein
the radar unit includes a polygon mirror having a plurality of side faces that have different angles with respect to a bottom face, wherein the radar unit emits the transmission waves in the vehicle-height direction by reflecting the transmission waves by each of the side faces of the polygon mirror,
the recognition range setting means stores face numbers assigned to the side faces of the polygon mirror in accordance with the different angles and causes the transmission waves to be emitted in the recognition range by reflecting the transmission waves with side faces having face numbers corresponding to the recognized range, and
the recognition range switching means sets new face numbers of the side faces to a higher level in the vehicle-height direction than the side faces of the face numbers stored in the recognition range setting means and causes each of the side faces of the new face numbers of the polygon mirror to reflect the transmission waves, the new face numbers corresponding to the new recognition range.

6. The object recognition device according to claim 4, wherein
the side faces of the polygon mirror are numbered in an order from a side face for emitting the transmission waves to a highest level in the vehicle-height direction to a side face for emitting the transmission waves to a lowest level, and
the recognition range switching means switches the face numbers corresponding to the recognition range before switching to face numbers of side faces that reflect the transmission waves to a higher level in the vehicle-height direction than the side faces of the face numbers corresponding to the recognition range before switching.

7. The object recognition device according to claim 5, wherein
the recognition range setting means sets three face numbers as the face numbers corresponding to the recognition range, the three face numbers including a first face number corresponding to a predetermined angle relative to a forward direction of the vehicle, and first and second face numbers disposed on opposite sides of the first face number, and
the recognition range switching means switches the face numbers corresponding to the recognition range before switching to a face number of a side face that reflects the transmission waves to a higher level in the vehicle-height direction than the side faces of the face numbers corresponding to the recognition range before switching, and the face number corresponding to the reference angle.

8. The object recognition device according to claim 4, wherein
the side faces of the polygon mirror are numbered in an order from a side face reflecting the transmission waves to a highest level in the vehicle-height direction to a side face reflecting the transmission waves to a lowest level, and
the recognition range switching means decreases or increases the face numbers of the side faces corresponding to the recognition range set before switching by one.

9. The object recognition device according to claim 5, wherein
the side faces of the polygon mirror are numbered in an order from a side face reflecting the transmission waves to a highest level in the vehicle-height direction to a side face reflecting the transmission waves to a lowest level, and
the recognition range switching means decreases or increases the face numbers of the side faces corresponding to the recognition range set before switching by one.

10. The object recognition device for vehicle according to claim 4, wherein
the side faces of the polygon mirror are numbered in an order from a side face reflecting the transmission waves to a highest level in the vehicle-height direction to a side face reflecting the transmission waves to a lowest level,
the recognition range setting means sets a predetermined number of side faces which have consecutive face numbers as the side faces corresponding to the recognition range, and
the recognition range switching means decreases or increases each of the consecutive face numbers of the side faces corresponding to the recognition range set before switching by one.

11. The object recognition device for vehicle according to claim 5, wherein
the side faces of the polygon mirror are numbered in an order from a side face reflecting the transmission waves to a highest level in the vehicle-height direction to a side face reflecting the transmission waves to a lowest level,
the recognition range setting means sets a predetermined number of side faces which have consecutive face numbers as the side faces corresponding to the recognition range, and
the recognition range switching means decreases or increases each of the consecutive face numbers of the side faces corresponding to the recognition range set before switching by one.
